(19) United States
(12) Patent Application Publication
(10) Pub. No.: US 2015/0196973 A1
(43) Pub. Date: Jul. 16, 2015

(54) APPARATUS FOR LASER PROCESSING OF HIDDEN SURFACES

(71) Applicant: Siemens Energy, Inc., Orlando, FL (US)

(72) Inventors: Gerald J. Bruck, Oviedo, FL (US); Ahmed Kamel, Orlando, FL (US)

(73) Assignee: Siemens Energy, Inc., Orlando, FL (US)

(21) Appl. No.: 14/155,629

(22) Filed: Jan. 15, 2014

(51) Int. Cl. B23K 26/03; B23K 26/06; B23K 26/14; B23K 26/04

(52) U.S. Cl. CPC B23K 26/032; B23K 26/041; B23K 26/046; B23K 26/0639; B23K 26/14

(57) ABSTRACT

A laser emitter (36) emits a laser beam (37) through optics (38) that focus the beam, and a beam deflection device (40) redirects the beam. An elongated probe (30) receives the beam at a proximal end (50) and has a remote mirror (24) that reflects the beam toward a hidden surface (32) to be processed by scanning of the beam. A programmable controller (54) controls focusing and deflection of the beam to move the focal point and spot of incidence (39) in three dimensions, causing the spot to traverse the hidden surface. The probe may optionally have translation (42) and rotation (44) actuators and a remote mirror pivot actuator (58) controlled by the controller. The probe may be L-shaped (30A, 30B) to reach around an intervening structure (27). An autofocus mechanism (67) may be provided to focus the beam during scanning or verify focus profiles before scanning.

### FIELD OF THE INVENTION

The invention relates to laser treatment of hidden surfaces for scribing, welding, and other melting or ablation processes, and particularly for scribing of thermal barrier coatings for strain tolerance on interior surfaces with limited access

### BACKGROUND OF THE INVENTION

The capability of precisely applying an intense energy beam has resulted in many commercial uses for industrial lasers. Three-dimensional laser scanning optics rated up to about 10 kW of constant power are used for rapid spot welding in automotive parts manufacture. Laser scribing of surfaces is done to improve strain tolerance in thermal barrier coatings on high-temperature components of gas turbine engines. U.S. Pat. No. 4,694,136 describes a laser probe with a remote mirror for laser welding of sleeves inside steam generator tubes in a nuclear power plant. The probe rotates about its axis, which is substantially coincident with the tube and sleeve axes. The probe head maintains a fixed distance of the remote mirror from the interior surface of the sleeve being welded. Thus, focus is simply fixed on the interior surface as the laser spot describes a circular or helical weld path However, this apparatus and process is limited to interior surfaces of cylindrical symmetry, such as interiors of cylindrical tubes

### BRIEF DESCRIPTION OF THE DRAWINGS

The invention is explained in the following description in view of the drawings that show:

FIG. 1 is a schematic view of an apparatus according to aspects of the invention for laser scanning of hidden surfaces.

FIG. 2 is a sectional view taken along line 2-2 of FIG. 1 showing a contour of the hidden surface to be processed.

FIG. 3 is a view of beam deflection taken along line 3-3 of FIG. 1.

FIG. 4 shows a hidden surface with laser scan line features such as trenches.

FIG. 5 shows a probe embodiment with a pivotally actuated remote mirror.

FIG. 6 shows an embodiment with an L-shaped probe and two remote mirrors

FIG. 7 shows an auto-focus mechanism

### DETAILED DESCRIPTION OF THE INVENTION

The present inventors have found that component geometries sometimes block access to some component surfaces for current laser equipment. Contoured surfaces also create problems for scribing equipment to maintain laser focus on the complex surface. The present inventors are unaware of any apparatus for directing a continually focused scanning laser beam to an interior or hidden surface of a non-cylindrical component

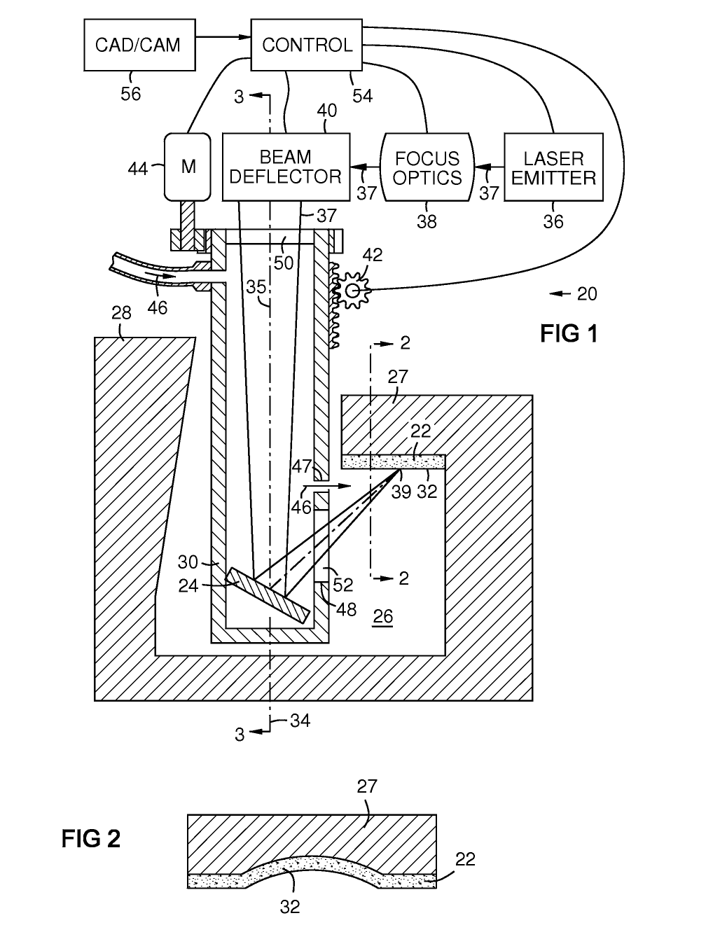

FIG. 1 illustrates an apparatus 20 for scribing trenches in a thermal barrier coating 22 on a hidden surface, or for other scanned laser processing thereof A “hidden surface” herein is an interior surface of an object or other surface of an object to which direct line of sight access is restricted A remote mirror 24 is inserted into an interior volume 26 or beyond an intervening portion 27 of a component 28 by means of a probe 30 such as a tube or robotic arm The component has a hidden surface 32 to be processed (such as by laser scribing) that is inaccessible by standard laser optics The surface 32 may not be flat (FIG. 2) and may not be cylindrical about an optical axis 34 of the probe. For this reason, continual focus adjustment during scanning is needed. A laser emitter 36 generates a laser beam 37, with a beam centerline 35. Focusing optics 38 adjustably converge the beam to a desired focal point, causing a spot of incidence 39 of the beam on the hidden surface The spot 39 may be at the focal point itself or before or past the focal point, depending on the desired effect A beam deflector 40 controls the beam direction, for example by galvanometer-driven mirrors and/or by other laser scanning mechanisms. For example two galvanometer mirrors on respective orthogonal pivot axes may scan the spot 39 over two dimensions of the hidden surface

The third dimension may be provided by focusing optics 38 that adjust the distance of the focal point to produce a desired position and size of the spot 39. A robotic axial actuator 42 of the probe may provide additional control of the spot position and the beam incidence angle A robotic rotation actuator 44 may be provided to position the probe 30 around its axis 34. One or both of these actuators 42, 44 may optionally be used to translate and/or rotate the probe during scanning as an additional movable element of beam deflection. The actuators 42 and 44 may be any type of position and motion actuators, such as stepper motors, servo motors, and hydraulic pistons. The probe 30 may be sealed at its proximal end by a laser-transparent window 50. A purge gas 46 may be pumped into the probe, and may exit it via the beam exit aperture 48 to keep contaminants out of the probe. Alternately, the beam exit aperture 48 may be sealed by a laser-transparent window 52. In such embodiment, the purge gas 46 may exit a remote gas outlet 47 to purge smoke from the work area.

FIG. 2 is a sectional view taken along line 2-2 of FIG. 1 showing a contour of the surface 32 to be processed The shape of the surface 32 may be defined in a programmable controller 54 by three dimensional surface geometry parameters, which are interpreted by logic in the controller to control the apparatus elements 36, 38, 40, 42, 44. The geometry parameters may be imported into the controller from a CAD/CAM system 56

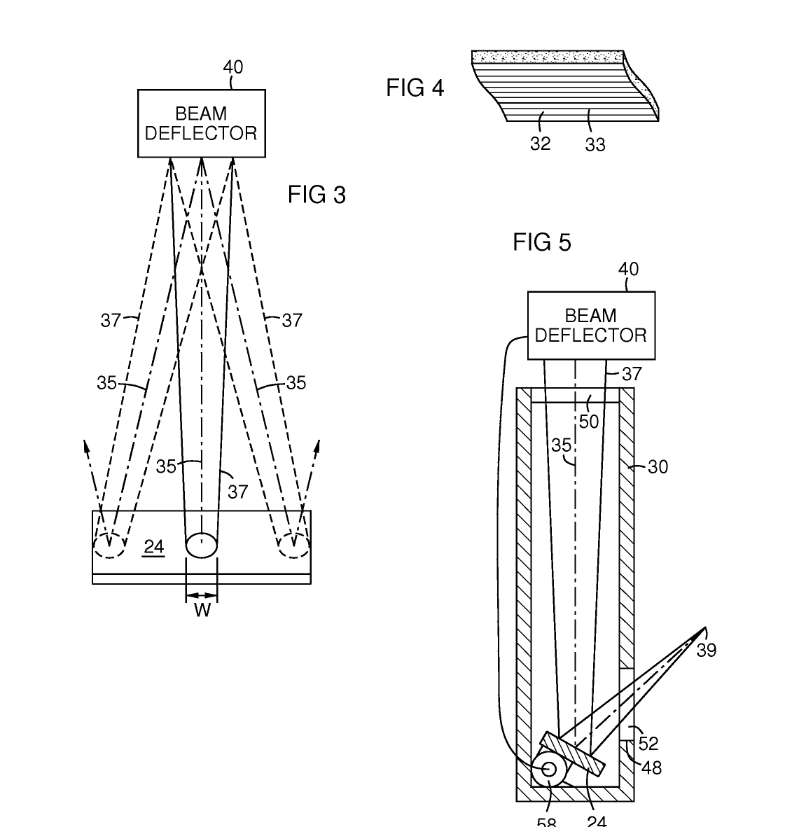

FIG. 3 is a view of beam deflection as seen along line 3-3 of FIG. 1 showing a remote mirror 24 that is wide enough to reflect a range of scan angles of the beam 37. For example, the remote mirror 24 may be dimensioned in width and/or length sufficiently to accommodate at least 3 beam widths W. This works where there is sufficiently large access into the component 28 to admit such a mirror. Alternately or additionally, the needed scan range can be provided by rotating, translating, and focusing the probe 30 in a coordinated way using a smaller remote mirror.

FIG. 4 shows a hidden surface 32 with laser scan lines 33 that form features such as trenches in the surface and/or weld or otherwise treat the surface with heat. The features such as trenches may be parallel or cross-hatched or may form arrays of disconnected depressions or any other surface features of removal or heating, for example created by rastering of the laser beam.

FIG. 5 shows an embodiment using a remote mirror with a pivotal actuator 58 such as a galvanometer, which may be electrically connected to the beam deflector 40 or the controller to function as part of, or in coordination with, the beam deflector 40

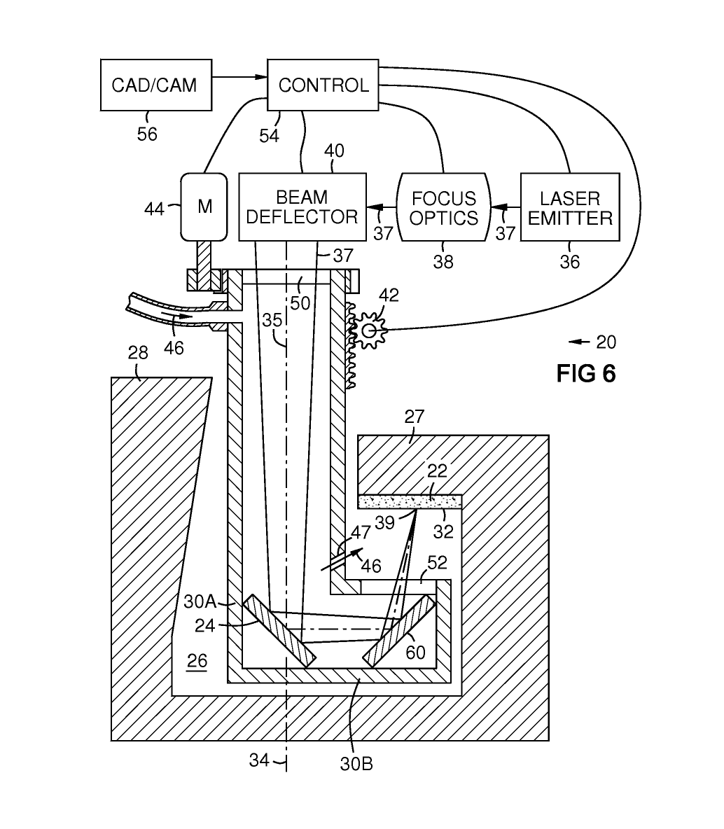

FIG. 6 shows an embodiment with an L-shaped probe having a longer arm 30A and a shorter arm 30B. A first remote mirror 24 in the longer arm and a second remote mirror 60 in the shorter arm work together to provide a beam that is closer to normal to a working surface 32 behind an intervening structure 27. The probe 30A, 30B may be embodied as either a hollow or skeletal articulated robotic arm, in which the shorter arm or tube 30B controllably pivots on the longer arm or tube 30A. In such embodiment, the first remote mirror 24 may be pivotally actuated as shown in FIG. 5 and controlled to maintain alignment of the beam 37 between the mirrors 24 and 60 over a range of articulation pivot angles. Alternately, one or both of the mirrors 24, 60 may be moved individually or jointly together with or separately from movement of the probe to accomplish a desired movement of the spot of incidence 39.

Combinations of the described beam deflection options may be used to achieve a desired flexibility, reach, and 3-dimensional scan control of the beam spot 39 for a given application. Probe arms 30A and 30B may also be telescoping for additional flexibility. Focusing optics 38 would be coordinated in conjunction with such telescoping function to maintain desired focus condition on the process surface.

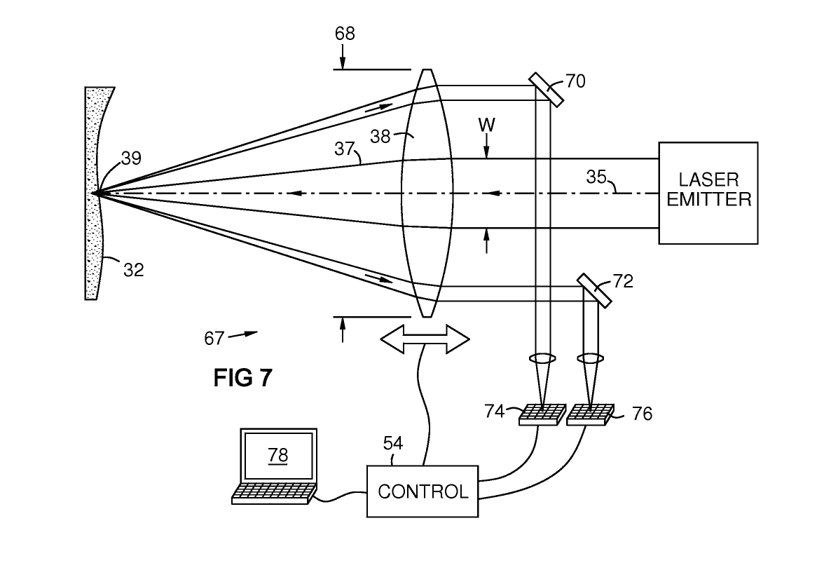

FIG. 7 illustrates an auto-focus mechanism 67, which may be generally of a type called “phase detection” as used in cameras. The focusing optics 38 may provide a wider aperture 68 than is needed for the width W of the laser beam 37, allowing room beside the beam for first and second autofocus mirrors 70, 72 that redirect images of the laser spot 39 to respective charge coupled devices (CCD) 74, 76. The autofocus mirrors 70, 72 do not need to be reflex mirrors in this configuration They can be stationary, because the working beam 37 can pass between them. Only a single row of each CCD is needed for the autofocus function However, two dimensional CCD arrays may be provided as shown to act as cameras for image feedback to an operator display 78 for visually checking the work Alternately a reflex mirror (not shown) may redirect a central image to a different CCD for this purpose. The autofocus CCD arrays 74, 76 provide intensity profiles to an autofocus function of the controller that compares intensity peaks of the image of the spot 39 as seen through opposite sides of the optical aperture The autofocus function can compare the two images to determine how far, and in which direction the focal point departs from the working surface 32 using known phase detection autofocus methods. The controller can thus adjust the focus in real time to create a desired spot size that follows the contours of the surface 32 Alternately, a low-powered preliminary scan pass may be performed along each laser scan line over the working surface 32 to establish focusing profiles to be followed during high powered processing. A low powered beam may be provided by partly blocking the working laser beam 37 with a beam reducer or by temporarily introducing a low powered beam into the beam path 35 via a reflex mirror (not shown) or other known means. Such preliminary processing can verify and perfect the focus parameters provided to the controller by the CAD/CAM system before laser processing begins.

In addition to scribing, operations such as cutting, welding, transformation hardening, glazing, cladding, heat treating, sintering and other processes could be performed by the apparatus herein. For processes requiring gas assistance, gas may be provided by the probe 30 with gas purging through it as described. For processes requiring material addition, a material can be pre-placed on the component surface or fed by a separate device such as powder or wire feeder. Lasers of various wavelengths and power profiles may be used. For welding, cladding and hardening, C0₂ or YAG or ytterbium fiber lasers of constant power may be used for example Some scribing operations may use Q switched and pulsed lasers.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. Apparatus for laser processing of a hidden surface, comprising:
a laser emitter that emits a laser beam;
focusing optics that focus the beam;
a beam deflection device that redirects the beam under program control;
a probe that receives the beam at a proximal end thereof;
a mirror at a distal end of the probe that reflects the beam toward a hidden surface; and
a controller that controls focusing and redirection of the beam to move a spot of incidence of the beam in three dimensions, causing the spot of incidence to traverse the hidden surface in a programmed scan pattern.

2. The apparatus of claim 1, further comprising an actuator that moves the probe under program control of the controller.

3. The apparatus of claim 1, wherein the probe comprises a tube with a laser-transparent window at the proximal end and a beam exit aperture at the distal end, and further comprising a purge gas supplied to the tube that exits the exit aperture.

4. The apparatus of claim 1, wherein the probe comprises a tube with a first laser-transparent window sealing the proximal end, a beam exit aperture at the distal end, a second laser-transparent window sealing the beam exit aperture, a purge gas supplied to the tube, and an outlet for the purge gas in the tube directed toward a work area of the hidden surface.

5. The apparatus of claim 1, wherein the beam deflection device controls a direction of the laser beam to move the spot of incidence over two dimensions of the hidden surface, and the focusing optics move the spot of incidence over a third dimension thereof.

6. The apparatus of claim 1, wherein the beam deflection device comprises an actuator on the remote mirror that pivots the remote mirror under control of the controller, the beam deflection device controls a direction of the laser beam to move the spot of incidence over two dimensions of the hidden surface, and the focusing optics move the spot in a third dimension thereof.

7. The apparatus of claim 1, wherein the probe is L-shaped, comprising a first longer arm and a second shorter arm, the remote mirror being at a distal end of the longer arm, and a second remote mirror at a distal end of the shorter arm.

8. The apparatus of claim 1, wherein the probe comprises an L-shaped tube, comprising a first relatively longer tube and a second relatively shorter tube, the remote mirror being at a distal end of the longer tube, and further comprising a second remote mirror at a distal end of the shorter tube.

9. The apparatus of claim 8, further comprising a purge gas supplied to the longer tube and exiting the probe at a gas outlet directed toward a work area of the hidden surface

10. The apparatus of claim 1, wherein the remote mirror comprises a width that accommodates at least three widths of the laser beam at incidence thereof with the remote mirror.

11. The apparatus of claim 1, further comprising an autofocus mechanism in the focusing optics that maintains a particular focal distance of the laser beam relative to the hidden surface during the traversal of the spot of incidence

12. The apparatus of claim 1, further comprising an autofocus mechanism in the focusing optics that provides a focusing profile for the controller to follow to move the spot of incidence along a scan line on the hidden surface.

13. The apparatus of claim 12, further comprising a camera element in the autofocus mechanism that provides an image of the scan line to an operator display

14. The apparatus of claim 1, wherein the traversal of the spot of incidence scribes strain relief trenches in a thermal barrier coating of the hidden surface.

15. Apparatus for laser processing of a hidden surface, comprising:
a laser emitter that emits a laser beam;
an optical focusing device that focuses the beam to a given focal point;
a beam deflection device that redirects the beam under program control;
an elongated probe that receives the beam at a proximal end thereof and reflects the beam by a remote mirror at a distal end of the probe; and
a programmable controller that controls the focusing device and the beam deflection device to move the focal point through 3-dimensional space, causing an incidence spot of the beam to traverse the hidden surface along a series of scan lines that create respective trenches for strain relief in the hidden surface

16. Apparatus for laser processing of a hidden surface, comprising:
a laser emitter that emits a laser beam;
an optical focusing device that focuses the beam to a given focal point;
a beam deflection device that moves the beam laterally under program control;
an elongated probe that receives the beam at a proximal end and reflects the beam by a first remote mirror at a distal end of the probe; and
a programmable controller that controls the focusing device and the beam deflection device to move the focal point through 3-dimensional space, causing an incidence spot of the beam to traverse the hidden surface for laser processing thereof.
